(19) United States
(12) Patent Application Publication
(10) Pub. No.: US 2025/0274403 A1
(43) Pub. Date: Aug. 28, 2025

(54) SYSTEM AND METHOD FOR COORDINATING NETWORKED RESOURCES

(71) Applicant: ROYAL BANK OF CANADA, Toronto (CA)

(72) Inventors: Obinna EZECHUKWU, London (GB); Hannah MORRIS, London (GB)

(21) Appl. No.: 18/589,838

(22) Filed: Feb. 28, 2024

(51) Int. Cl. H04L 47/70; H04L 47/78; H04L 47/80

(52) U.S. Cl. CPC H04L 47/826; H04L 47/781; H04L 47/803

(57) ABSTRACT

Systems, methods, and devices for coordinating data processing using multiple networked resources are provided. An electronic registry of networked resources is maintained. A data processing request is received. The request is divided among a plurality of data processing segments. For at least one given data processing segment of the plurality of data processing segments: a networked resource is selected from the registry of networked computing. The selecting based on at least one of: a metric indicating suitability of the selected networked resource for the given data processing segment; and an output of a random number generator. A time-out duration is set for completion of processing of the given data processing segment at the selected networked resource. The given data processing segment is routed to the selected networked resource.

### FIELD

This disclosure relates to data processing, and more particularly distributed processing using multiple networked resources.

### BACKGROUND

In various forms of networked or otherwise distributed data processing systems, complex and/or multiple related processes are often routed to multiple computing resources for execution. There may be a high volume of requests for processing and/or a large volume of data associated with such requests, which require execution in a time-sensitive manner. Improvement to how such request are routed to computing resources is desired.

### SUMMARY

In accordance with one aspect, there is provided a computer-implemented method for coordinating data processing using multiple networked resources. The method includes maintaining an electronic registry of networked resources; receiving a data processing request; dividing the request among a plurality of data processing segments, and for at least one given data processing segment of the plurality of data processing segments: selecting a networked resource from the registry of networked computing, the selecting based on at least one of: a metric indicating suitability of the selected networked resource for the given data processing segment; and an output of a random number generator; setting a time-out duration for completion of processing of the given data processing segment at the selected networked resource; and routing the given data processing segment to the selected networked resource.

In accordance with another aspect, there is provided a computer-implemented system for coordinating data processing using multiple networked resources. The system includes a processing subsystem that includes one or more processors and one or more memories coupled with the one or more processors. The processing subsystem is configured to cause the system to: maintain an electronic registry of networked resources; receive a data processing request; divide the request among a plurality of data processing segments; and for at least one given data processing segment of the plurality of data processing segments: select a networked resource from the registry of networked resources, the selecting based on at least one of: a metric indicating suitability of the selected networked resource for the given data processing segment; and an output of a random number generator; set a time-out duration for completion of processing of the given data processing segment at the selected networked resource; and route the given data processing segment to the selected networked resource.

In accordance with yet another aspect, there is provided a non-transitory computer-readable medium or media having stored thereon machine interpretable instructions which, when executed by a processing system, cause the processing system to perform a method for coordinating data processing using multiple networked resources. The method includes: maintaining an electronic registry of networked resources; receiving a data processing request; dividing the request among a plurality of data processing segments; and for at least one given data processing segment of the plurality of data processing segments: selecting a networked resource from the registry of networked resources, the selecting based on at least one of: a metric indicating suitability of the selected networked resource for the given data processing segment; and an output of a random number generator; setting a time-out duration for completion of processing of the given data processing segment at the selected networked resource; and routing the given data processing segment to the selected networked resource.

Many further features and combinations thereof concerning embodiments described herein will appear to those skilled in the art following a reading of the instant disclosure.

### DESCRIPTION OF THE FIGURES

In the figures,

FIG. 1 is a network diagram of a network environment for distributed data processing, in accordance with an embodiment;

FIG. 2 is a schematic diagram of a request processing system, in accordance with an embodiment;

FIG. 3 is a schematic diagram of a routing engine of the request processing system of FIG. 2, in accordance with an embodiment;

FIG. 4 is a logic flow diagram of example operations performed at the request processing system of FIG. 2, in accordance with an embodiment;

FIG. 5 is a graph of price as a function of time for an example request, in accordance with an embodiment;

FIG. 6 is an example graph showing processing of multiple segments over time, in accordance with an embodiment;

FIG. 7 is a flowchart of example operations performed at the request processing system of FIG. 2, in accordance with an embodiment; and

FIG. 8 is a schematic diagram of a computing device, in accordance with an embodiment.

### DETAILED DESCRIPTION

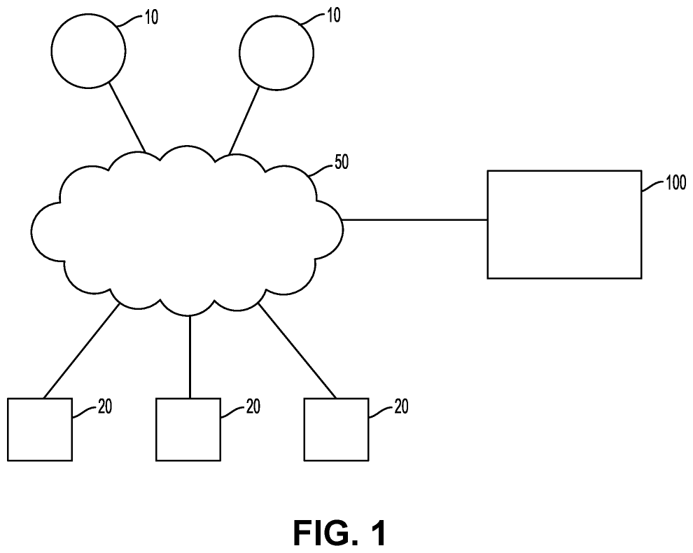

FIG. 1 is a diagram depicting a network environment for distributed data processing among a plurality of networked computing resources, in accordance with an embodiment. As depicted, this network environment includes a plurality of computing resources 20, each capable of executing resource requests. Resource requests may be requests for data processing, which may include, for example, data relating to graphics processing, transaction processing, monetary resources, or the like. Resource requests may originate from one or more requesting devices 10.

Within this network environment, resource requests from requesting devices are coordinated for processing using multiple computing resources 20 by operation of a request processing system 100. In various embodiments, request processing system 100 allocates resource requests among multiple computing resources 20 to optimize for one or more desired outcomes such as, for example, monetary cost of resources, compute cost of resources (e.g., network usage, memory usage, processor usage, etc.), network bandwidth, speed of completion, use of preferred computing resources 20, or the like. In various embodiments, request processing system 100 optimizes for such outcomes using a suitable combination of parameter-selection algorithms and/or machine learning models.

As depicted, request processing system 100 is interconnected with the plurality of requesting devices 10 and the plurality of computing resources 20 by way of a network 50. For example, request processing system 100 may receive a resource request from a requesting device 10 by way of a request signal transmitted via network 50. The request signal may encode parameters of the resource request such as a quantity of resources. In some embodiments, the request signal may also encode parameters relating to timing (e.g., when the resources are need) and/or a monetary amount (e.g., cost of the resources).

Requesting devices 10 may include devices operating under user control, e.g., to generate resource requests in response to user input. Requesting devices 10 may include devices operating under computer control, e.g., to generate resource requests automatically based on computer predictions, or other algorithmic control. A requesting device 10 may be a personal computing device such as a workstation computer, a laptop computer, a tablet computer, a smartphone, or the like. A requesting device 10 may be a server computer executing a server application with resource needs to be satisfied by resource requests. In an example, such a server application may include a computer graphics rendering application that requires compute resources to render computer graphics. In another example, such a server application may include a trading application such as for purchase or sale of securities (e.g., stocks, bonds, options or other negotiable financial instruments). In yet another example, such a server application may include a cryptocurrency mining application, which requires compute resources to verify cryptocurrency transactions and/or generate new cryptocurrency assets.

Computing resources 20 may include computing platforms managing a pool of resources (e.g., CPU resources, GPU resources, or the like). Computing resources 20 may include cloud-computing service providers which provide on-demand resources. Computing resources 20 may include platforms for the exchange (e.g., buy, sell, or trade) of resources.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPV4, IPv6, X.25, IPX or similar network. Portions of network 50 could be, for example, a GSM, GPRS, 3G, LTE, 5G, or similar wireless networks. Network 50 may include or be connected to the Internet. When network 50 is a public network such as the public Internet, it may be secured as a virtual private network.

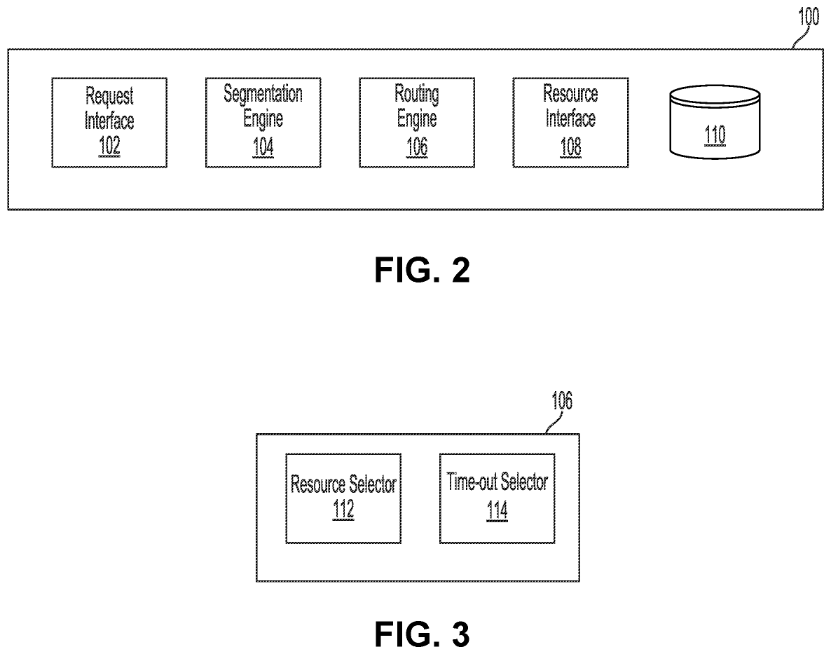

FIG. 2 is a schematic diagram of request processing system 100, in accordance with an embodiment. As depicted, request processing system 100 includes a request interface 102, a segmentation engine 104, a routing engine 106, a resource interface 108, and an electronic datastore 110.

Request interface 102 is configured to receive resource request signals via network 50, e.g., as transmitted by a requesting device 10. Request interface 102 processes a resource request signal to decode data defining a resource request, including, for example, an identifier of the type of resource being requested, a quantity of the resource, and any associated timing or monetary parameters. Decoding data defining a resource request may include, for example, decrypting the data using an appropriate key and/or key exchange.

Segmentation engine 104 is configured to allocate a resource request among a plurality of data processing segments, such that each segment may be routed to a different computing resource 20 for completion of the request. For example, if the resource request defines a total quantity to be processed, segmentation engine 104 divides this quantity into segments, each corresponding to a subset of the total quantity. Allocating the resource request among multiple computing resources 20 facilitates distributed processing by multiple computing resources 20. This distributed processing may allow the request to be completed faster, e.g., completion may be performed in parallel at multiple computing resources 20. This distributed processing may allow the request to be completed taking into account particular efficiencies of particular computing resources 20, or based on a predicted likelihood of availability of particular resources at a particular computing resources 20 at a given time.

In some cases, data processing segments may be divided to have substantially uniform size. In some cases, data processing segments may be divided to have a randomized size, e.g., the size may be chosen taking into account the output of a random number generator (including a pseudo-random number generator).

For example, a request for a quantity q̅ may be divided into n segments q₁, q₂, q₃, qᵢ, . . . , qₙ such that q̅Σᵢ₌₀ⁿqᵢ. In some embodiments, a randomized shift k(qᵢ) is applied to each slice qᵢ.

In some cases, dividing up the data processing segments may help avoid overwhelming a particular computing resource 20, e.g., by requesting more resources than available at that computing resource 20. In some cases, dividing up the data processing segments and allocating among multiple computing resources 20 may help evade unwanted monitoring by third parties such as competitors for the same resources.

Routing engine 106 is configured to route each data processing segment to a particular computing resource 20. In the depicted embodiment, resource selector 112 is implemented as an adaptive epsilon solution approach to a multi-armed bandit problem. Generally, a multi-armed bandit problem is an iterative problem, where a selection is made in each iteration from a set of alternatives, and the properties of each option are not fully known at the time of selection but may improve in each subsequent iteration.

Given a plurality of segments q₁, q₂, q₃, qᵢ, . . . , qₙ, each segment is routed to a computing resource a∈A, such that A⊆Ā, at time t, where:
Ā is the set of all available computing resources 20;
A is the subset of Ā that can be routed to at time t. The set A is derived by applying a filtration (or choice) function to Ā. An example function is one that limits A to computing resources where qᵢ meets the minimum/maximum quantity requirements. Another example function is one that limits A to computing resources that provide the type of resource being requested;
0≤t≤T is a timepoint between the start of execution and termination T of the request; and
a is selected by applying a selection function ƒ(a) to the elements of A.

Once routed, the quantity qᵢ is re-evaluated at time t+Δt, where Δt is derived from a time-out function g(t, a, qᵢ).

Routing engine 106 maintains a registry of computing resources 20 (e.g., set A). Such registry may be stored in, for example, electronic datastore 110.

In some embodiments, routing engine 106 maintains one or more machine learning models for mapping particular data processing segments to particular computing resources 20, for selection of one or more parameters for such segments, for implementing the selection function ƒ(a), or for implementing the time-out function g(t, a, qᵢ).

Referring now to the schematic diagram of FIG. 3, routing engine 106 includes a resource selector 112 and a time-out selector 114.

Resource selector 112 implements the above noted selection function ƒ(a). At a time point t for a given data processing segment, resource selector 112 selects a computing resource a∈A. In some embodiments, the selection takes into account prior knowledge (e.g., relating to successful or unsuccessful completion of past requests). In some embodiments, the selection includes a decision to perform random exploration of a set of computing resources, which may reduce the risk of self-reinforcing bias in the selection function.

In the depicted embodiment, resource selector 112 chooses between using prior knowledge, and random exploration of set A. This choice is determined by a randomly generated variable x∈R: └0,1┘ and a pre-defined exploration threshold h(t). When x≥h(t), random exploration of set A is performed, otherwise a computing resource a∈A is selected using prior knowledge. In some embodiments, this choice is performed on a segment-by-segment basis. In some embodiments, this choice is made on a request-by-request basis, and applied to each segment for a request.

When a choice is made to use prior knowledge, resource selector 112 selects a computing resource ā using a selection function ƒ(ā) such that ƒ(ā)=max ƒ(a): a∈A. In some embodiments, the selection function may be based on observable events such as historical completed quantities and quantities left uncompleted. A requested quantity may be fully or partially completed (in each case, the filledQty); and a shortfall is the quantity left not completed (leavesQty) from a requested quantity (sentQty). A shortfall may occur, for example, because the request expired, or was rejected or cancelled by a computing resource 20 or by request processing system 100.

In the depicted embodiment, the following selection function is used, for example:

$$f ( a ) = ( \frac{1}{1 + {R}_{t} ( a )} )$$

where:
Rₜ(a) is the observed shortfall at t.

One example formulation of Rₜ(a) is

$${R}_{t} ( a ) = \{ \begin{matrix}( \frac{{leavesQty}_{{a}_{t}}}{{sentQty}_{{a}_{t}}} ) , where leavesQty > 0 \\ 0\end{matrix} .$$

Other suitable selection functions will be apparent to those of ordinary skill.

Time-out selector 114 selects a time-period for maintaining a data processing segment at a computing resource 20 before it is re-evaluated (e.g., cancelled or amended if not completed or not canceled by the computing resource 20). This time period may be expressed as an interval Δt which elapses before a data processing segment qᵢ is re-evaluated.

In some embodiments, a pre-determined value of Δt is selected, which may be derived from heuristics, operator knowledge or statistical analysis. In some embodiments, Δt is selected taking into account a minimum processing time set by a computing resource 20. In some embodiments, Δt is selected taking into account expected delays in processing or queue times at computing resource 20. In some embodiments, Δt is selected based on a model of resource market indicators such as changes in available resources over time, dynamic changes in pricing over time, volatility over time, or the like.

Resource interface 108 is configured to send a request signal corresponding to a data processing segment to the particular computing resource 20 selected for that data processing segment. Resource interface 108 transmits the request signal to the particular computing resource 20 by way of network 50. In some embodiments, resource interface 108 encodes, within the request signal, data defining the time-out interval. In some embodiments, resource interface 108 encodes, within the request signal, data defining other request parameters such as resource price.

In some embodiments, resource interface 108 triggers execution of an interval timer (e.g., based on a system clock at request processing system 100) to count down the time-out interval. Expiry of the interval timer causes a routed data processing segment to be re-evaluated, e.g., for re-routing.

Each of request interface 102, segmentation engine 104, routing engine 106, and resource interface 108 may be implemented using a suitable combination of software and hardware components. Such software components may be implemented in whole or in part using conventional programming languages such as

Java, J #, C, C++, C#, Perl, Python, Visual Basic, Ruby, Scala, etc. Such software components of system 100 may be in the form of one or more executable programs, scripts, routines, statically/dynamically linkable libraries, or servlets.

Electronic datastore 110 may implement a conventional relational, object-oriented, or document-oriented database, such as Microsoft SQL Server, Oracle, DB2, Sybase, Pervasive, MongoDB, NoSQL, etc.

In some embodiments, request processing system 100 includes features adapting it to perform certain specialized purposes, e.g., in relation to specific types of resources.

### Example Use Cases-Trading of Securities

In some embodiments, request processing system 100 is implemented as part of an automated trading platform for trading securities, e.g., stocks, bonds, options or other negotiable financial instruments. In such embodiments, data processing requests may relate to data defining a trade (e.g., a buy or a sale) of securities or similar resources. Data processing requests may be routed to trading venues having appropriate computing resources 20 for processing such requests. Such trading venues may include, for example, a combination of public exchanges and dark pools. A trading venue may include an ECN (electronic communication network).

In some embodiments, request processing system 100 may operate in conjunction with one or more automated trading agent that generate requests. In some embodiments, a requesting device 10 may implement one or more automated trading agents. In some embodiments, automated trading agents may execute at request processing system 100.

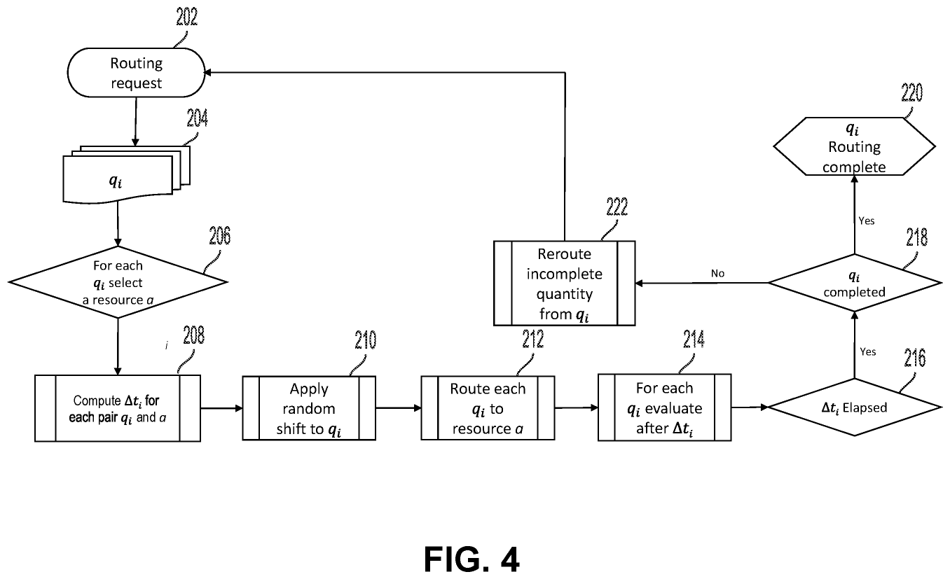

The operation of request processing system 100 as part of an automated trading platform is further described with reference to the logic flow diagram of FIG. 4, in accordance with an embodiment.

In the depicted embodiment, request processing system 100 operates in concert with one or more automated trading agents which compute trading trajectories (or schedules), e.g., trading signals and the time points at which trades are meant to occur or be sent out to the market, e.g., via a smart order router. In some embodiments, the functionality of request processing system 100 may be implemented within a smart order router.

At logic block 202, request processing system 100 determines the quantity of a given resource subject to outstanding requests, which includes new requests received from requesting devices 10 as well as portions of prior requests that have not been completed as of the expiry of an associated time-out interval. Request processing system 100 computes, for all venues a∈Ā with open requests, an incomplete quantity where a time-out interval Δt has elapsed and a quantity routed to venue a is not fully filled. This incomplete quantity is computed as:

$$LeayesQty = SentQty - FilledQty .$$

Request processing system 100 records LeavesQty against a particular venue a, e.g., to be used later by the selection function.

Request processing system 100 checks for any new quantity to be routed, e.g., as defined in requests received via request interface 102. A total quantity to be processed is computed as a sum q of incomplete quantities and new quantities. The quantity q represents the total quantity to be routed to venues a.

Request processing system 100 applies a filter function to the set of available venues Ā to derive a subset corresponding to viable venues A⊆Ā. The filter function may take into account a market/venue impact requirement, where impact is a change in quantifiable market conditions, such as, e.g., price, quoted volume, etc.

At logic block 204, the total quantity q is divided into a plurality of segments qᵢ by segmentation engine 104.

At logic block 206, request processing system 100 selects a particular venue a to send the quantity qᵢ. Selection of the particular venue is performed by either selecting a venue a∈A at random by exploration of the set of venues A, or by applying the selection function ƒ(a) such that for the selected venue ā, ƒ(a)=max ƒ(a): a∈A. In some embodiments, this selection function can take into account historical data, which may include, for example, historical samples of venue fills and fails (successes and failures) for the various elements of the set A.

Routing engine 106 may trigger venue exploration in manners discussed above. For example, a venue a∈A to route qᵢ may be selected as follows:
Calculate exploration threshold h(t)
Generate a random value x∈R: └0,1┘
If x≥h(t), select a random element a∈A
Else select venue ā, where ƒ(ā)=max ƒ(a): a∈A

In some embodiments, routing engine 106 may implement a machine learning model that selects a venue that optimizes one or more of the following parameters:

Price: which may be the price closest to the rest of the market i.e., is not adversely worse than the aggregated market average; the price closest to that which a client intended to fill the trade; or the price that is closest to the side of the trade. Side is in this context refers to whether the client is a buyer or a seller in the transaction. In the case of a buyer, their price would be the bid (buy) price of the asset, and for a seller, the ask (sell) price of the asset. The price on the side of the client transaction can be referred to as a near-touch price; whilst the price on the opposite side is the far-touch. A mid-price is the average of the near and far touch prices.

Speed of execution: which can also be referred to as “hold time”; and is the amount of time it takes to complete an order either from its arrival time or a specified start-time.

Costs: the economic costs of a trade include the shortfall (difference) from specific benchmarks, such as, e.g., the market price at arrival, the average price over a period weighted by time (time weighted average price), or by time and volume (volume weighted average price), or the fees associated with the execution of the trade.

Market impact: the impact of a trade is the change in quantifiable market conditions (such as, e.g., price, quoted volume etc.) that can reasonably (or likely) be attributed to a trade using a mathematical formulation.

At logic block 208, a time-out interval Δtᵢ is set for the quantity qᵢ. In the depicted embodiment, this time-out interval is computed by time-out selector 114 as follows.

$$Δ t = \frac{{σ}_{t} \times {c}_{t}}{\overline{m}}$$

where:
σₜ is the historical or observed volatility of the resource (e.g., a security) subject of a request;
cₜ is the number of price points (or distance) the market (or venue) price would have to move to cross the limit price of qᵢ; and
m̅ is the average trade on the venue.

Other ways of computing Δt will be apparent to those of ordinary skill.

In the context of trading securities, the time-out interval Δt may also be referred to as a minimum “resting time”, corresponding to a duration of time that must elapse before the quantity q; is touched again.

In some embodiments, this resting time may be selected taking into account minimum lifetime on orders, which may be set by particular venues. This minimum lifetime is sometimes also referred to as a minimum quote lifetime (MQL). The MQL may be mandated by regulation, market, or venue codes of conduct.

In some embodiments, a resting time model may be employed. Such a model aims to compute the time-to-fill (TTF) for qᵢ by considering a number of market indicators, e.g., traded volume, price, and volatility. A resting time model can either be historical, real-time, or a combination of both.

It may be desirable to set the resting time to be sufficiently high to avoid re-pegging too soon. If the resting time is too low, early re-pegging may lead to the model chasing the market as opposed to waiting for volatility to drive the price back favourably.

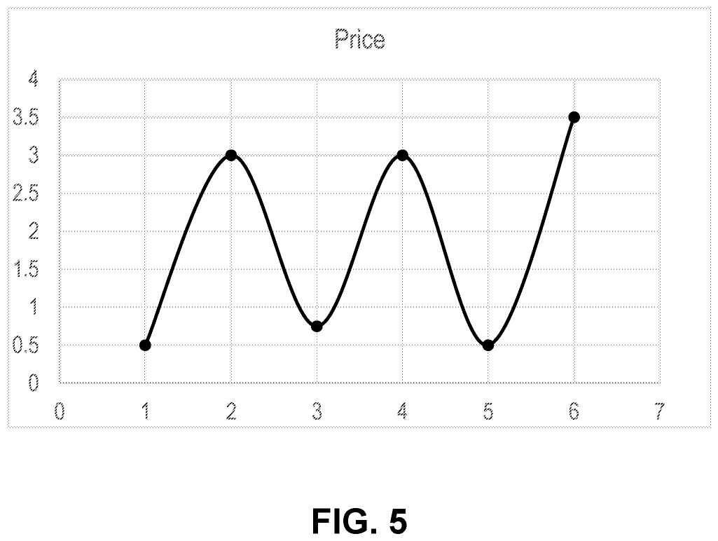

FIG. 5 illustrates a graph of price (y-axis) as a function of time (x-axis). In this example, a buy order placed at the price of timepoint 1 will fill provided the resting time is set so that the order remains in place until time point 5. Therefore, a choice of resting time which allows the order to remain in place until timepoint 5 would lead to the most optimal outcome for this example order.

Referring again to FIG. 4, at logic block 210, a random shift is applied to the desired quantity qᵢ, prior to sending it to the selected venue. In the depicted embodiment, the randomized quantity is pegged at the venue's localized price (best bid/offer). In some embodiments, the randomized quantity may be pegged at a best-bid-offer (as reflected in a single tape or other transaction record). This randomized quantity and peg may reduce the risk of information or price leakage.

At logic block 212, the quantity qᵢ is routed to the selected venue a. A request signal is sent to venue by request interface 108. Once sent, request processing system 100 will not modify the request to venue a for quantity qᵢ for the selected minimum resting time.

Once the resting time has passed, the order would either have filled, or the market would have moved—either sufficiently to require the order to be re-pegged to a new price or venue; or within a tolerance that allows the order to remain as is.

As shown in logic block 214, after Δtᵢ for the quantity q has elapsed, request processing system 100 reconsiders the quantity qᵢ. Thus, request processing system 100 waits until Δtᵢ has elapsed (logic block 216).

At logic clock 218, request processing system 100 checks whether quantity qᵢ has been fully completed, i.e., LeavesQty has a value of zero. If so, routing for quantity qᵢ is determined complete (logic block 220). If quantity qᵢ has not been fully been completed, then the LeavesQty needs to be rerouted (logic block 222. To effect this rerouting, the LeavesQty is returned as an open quantity at logic block 202.

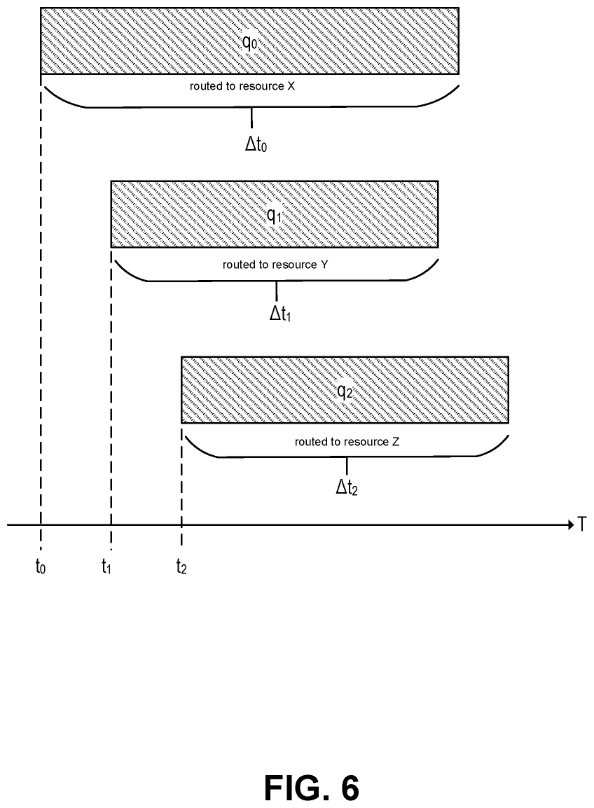

Embodiments of content processing system 100 may produce various technical effects and provide various technical advantages. For example, in some embodiments, the routing function of content processing system 100 is completed by processing each segment (quantity qᵢ) serially. FIG. 6 depicts an example of such serial processing, with quantity q₀ routed at time to, quantity qᵢ routed at time t₁, quantity q₂ routed at time t₂, and so on. Despite this serial processing of segments, the requests for processing these segments may be processed at multiple computing resources 20 in parallel. For example, because t₀+Δt₀ and t₁+Δt₁ extend past t₂, for a period after t₂ there are at least three segments being processed in parallel, at respective computing resources 20. Thus, one technical effect is that parallel processing may be obtained via a single process. In some embodiments, such process may be implemented as a single-threaded process.

In some embodiments, being able to implement this routing function in a single process allows it to be implemented within an algorithmic trading process, rather than within a separate order router.

### Example Use Cases—Computing Resources

In some embodiments, request processing system 100 may be implemented as part of a distributed system for managing computing resources. Request devices 10 may be operated by one or more businesses requiring computing resources (e.g., CPU resources, GPU resources, storage, or the like). Requests may specify, for example, the type of computing resources required and the application of the computing resources (e.g., for rendering computer graphics, executing AI models, conducting simulations, mining cryptocurrency, or the like). Requests may specify, for example, a quantity of computing resources (e.g., a quantity of data, a quantity of bandwidth, a quantity of memory, a quantity of compute (FLOPS), or the like. Requests may also specify timing constraints, e.g., when the required processing should be completed. Requests may also specify a monetary amount, e.g., a price offered for completion of the requested processing.

Request processing system 100 routes the request such that segments of request are transmitted to particular selected resources 20. In various embodiments, each resource 20 may correspond to a particular supercomputer, a particular cloud computing platform, particular data center, or the like.

Upon expiry of a time-out period, request processing system 100 evaluates completion of a corresponding segment of the requested processing.

In some embodiments, request processing system 100 may be used to achieve distributed processing of complex and/or data-intensive processing tasks.

### Example Use Cases—Transportation

In some embodiments, request processing system 100 may be implemented as part of a logistics platform for transportation of goods (e.g., parcels, foodstuff, etc.). Requesting devices 10 may be operated by one or more businesses requiring transportation services. Requests may specify, for example, a type of good to be transported, a quantity of good to be transported, a source location, a destination location, and so on. Requests may also specify timing constraints, e.g., based on delivery service standards to end customers, perishability of goods, or the like. Requests may also specify a monetary amount, e.g., a price offered for completion of the requested transport.

Request processing system 100 routes the request such that segments of request are transmitted to particular selected resources 20. In various embodiments, each resource 20 may correspond to a particular transportation vehicle, a particular transportation hub, a fleet management service that manages a plurality of vehicles, or the like.

Upon expiry of a time-out period, request processing system 100 evaluates completion of a corresponding segment of the requested transportation.

In some embodiments, request processing system 100 may be used to achieve time-sensitive and cost-effective delivery of goods.

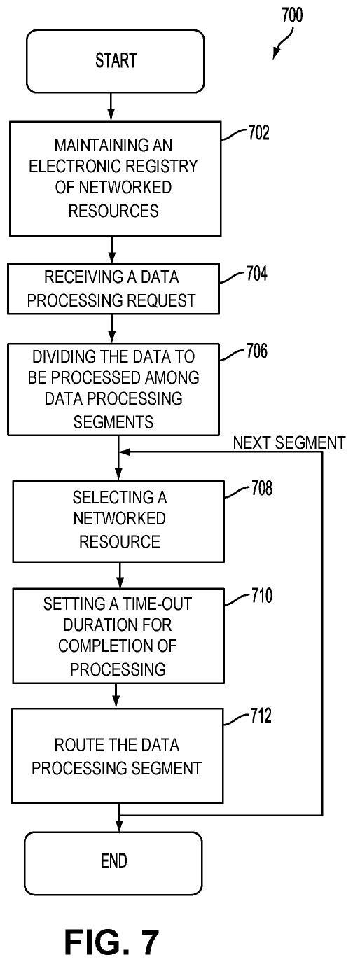

The operation of request processing system 100 is further described with reference to the flowchart depicted in FIG. 7, in accordance with an embodiment.

As depicted, request processing system 100 performs example operations depicted at blocks 700 and onward, in accordance with an embodiment.

At block 702, routing engine 106 maintains an electronic registry of networked computing resources 20. Such electronic registry is maintained by routing engine 106 in electronic datastore 110.

At block 704, request interface 102 receives a data processing request.

The request is received by way of network 50. The request defines a quantity q of resource to be processed.

At block 706, segmentation engine 104 dividing the request among a plurality of data processing segments. For example, the quantity q may be divided among quantities qᵢ.

At block 708, for a given data processing segment of the plurality of data processing segments, routing engine 106 selects a networked resource from the registry of networked resources. This selection is based on at least one of a metric indicating a suitability of the selected networked resource for the given data processing segment and an output of a random number generator. This metric may include an output of the selection function ƒ(a). The output of the random number generator may trigger a decision to perform random exploration of the networked resources. The output of the random number generator may be used to randomly select a particular one of the networked resources, e.g., based on a mapping of the randomly generated value to a registry of networked resources.

At block 710, for the given data processing segment, time-out selector 114 sets a time-out duration for completion of processing of the given data processing segment at the selected networked resource. The time-out duration may be set based at least partly on a minimum processing time of the selected networked resource. The time-out duration may be set based at least partly on an expected processing time of the selected networked resource. The time-out duration may be set based at least partly on a pre-determined duration.

At block 712, the given data processing segment is routed to the selected networked resource. Routing includes resource interface 108 sending a request signal corresponding to a data processing segment to the selected networked resource.

Blocks 708, 710, and 712 may be repeated for one or more subsequent quantities qᵢ.

It should be understood that steps of one or more of the blocks depicted in FIG. 7 may be performed in a different sequence or in an interleaved or iterative manner. Further, variations of the steps, omission or substitution of various steps, or additional steps may be considered.

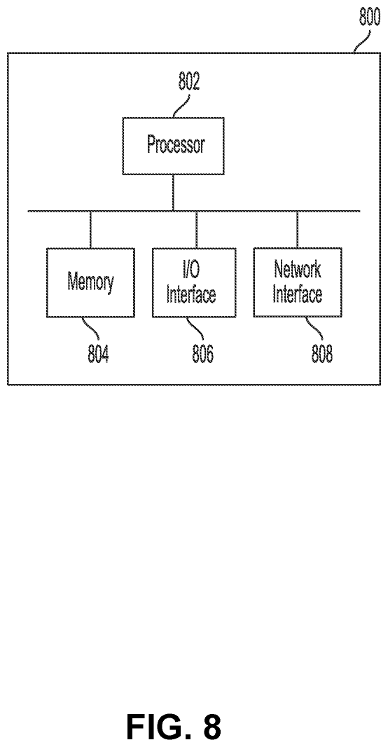

FIG. 8 is a schematic diagram of a computing device 800 suitable for implementing request processing system 100, in accordance with an embodiment. As depicted, computing device 800 includes one or more processors 802, memory 804, one or more I/O interfaces 806, and, optionally, one or more network interface 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may store code executable at processor 802, which causes request processing system 100 to function in manners disclosed herein.

Each I/O interface 806 enables computing device 800 to interconnect with one or more input devices, such as a keyboard, mouse, camera, touch screen and a microphone, or with one or more output devices such as a display screen and a speaker.

Each network interface 808 enables computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Each computing devices may be connected in various ways including directly coupled, indirectly coupled via a network, and distributed over a wide geographic area and connected via a network (which may be referred to as “cloud computing”).

For example, and without limitation, each computing device 800 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

In some embodiments, one or more computing devices 800 may be used to implement a requesting device 10. In some embodiments, one or more computing devices 800 may be used to implement a resource 20.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A computer-implemented method for coordinating data processing using multiple networked resources, the method comprising:
maintaining an electronic registry of networked resources;
receiving a data processing request;
dividing the request among a plurality of data processing segments; and
for at least one given data processing segment of the plurality of data processing segments:
selecting a networked resource from the registry of networked computing, the selecting based on at least one of:
a metric indicating suitability of the selected networked resource for the given data processing segment; and
an output of a random number generator;
setting a time-out duration for completion of processing of the given data processing segment at the selected networked resource; and
routing the given data processing segment to the selected networked resource.

2. The computer-implemented method of claim 1, further comprising:
upon expiry of the time-out duration, receiving an indication of an unprocessed portion of the given data processing segment; and
re-allocating the portion of unprocessed data to a new data processing segment.

3. The computer-implemented method of claim 1, wherein a quantum associated with the given data processing segment is set at least partly based on an output of a random number generator.

4. The computer-implemented method of claim 1, wherein the setting a time-out duration is based at least partly on a minimum processing time of the selected networked resource.

5. The computer-implemented method of claim 1, wherein the setting a time-out duration is based at least partly on an expected processing time of the selected networked resource.

6. The computer-implemented method of claim 1, where in the setting a time-out duration is based at least partly on a pre-determined duration.

7. The computer-implemented method of claim 1, wherein the selecting includes exploring the networked resources based at least partly on the output of the random number generator.

8. The computer-implemented method of claim 1, wherein the selecting includes applying an adaptive algorithm that takes into account a completion metric associated with the given networked resource.

9. The computer-implemented method of claim 1, wherein the data processing request includes a request for computing resources.

10. The computer-implemented system of claim 1, wherein the data processing request includes a request for a trade of a security.

11. The method of claim 10, wherein the selecting is performed within an algorithmic trading process.

12. The method of claim 1, further comprising:
filtering the networked resources for a subset of viable networked resources.

13. A computer-implemented system for coordinating data processing using multiple networked resources, the system comprising:
a processing subsystem that includes one or more processors and one or more memories coupled with the one or more processors, the processing subsystem configured to cause the system to:
maintain an electronic registry of networked resources;
receive a data processing request;
divide the request among a plurality of data processing segments; and
for at least one given data processing segment of the plurality of data processing segments:
select a networked resource from the registry of networked resources, the selecting based on at least one of:
a metric indicating suitability of the selected networked resource for the given data processing segment; and
an output of a random number generator;
set a time-out duration for completion of processing of the given data processing segment at the selected networked resource; and
route the given data processing segment to the selected networked resource.

14. The computer-implemented system of claim 13, wherein the data processing request includes a request for computing resources.

15. The computer-implemented system of claim 13, wherein the data processing request includes a request for a trade of a security.

16. The computer-implemented system of claim 13, wherein the data processing request includes a request for physical resources.

17. The computer-implemented system of claim 13, wherein a quantum associated with the given data processing segment is set at least partly based on an output of a random number generator.

18. The computer-implemented system of claim 13, the time-out duration is set based at least partly on a minimum processing time of the selected networked resource.

19. The computer-implemented system of claim 13, the time-out duration is set based at least partly on an expected processing time of the selected networked resource.

20. The computer-implemented system of claim 13, the time-out duration is set based at least partly on a pre-determined duration.

21. A non-transitory computer-readable medium or media having stored thereon machine interpretable instructions which, when executed by a processing system, cause the processing system to perform a method for coordinating data processing using multiple networked resources, the method comprising:
maintaining an electronic registry of networked resources;
receiving a data processing request;
dividing the request among a plurality of data processing segments; and
for at least one given data processing segment of the plurality of data processing segments:
selecting a networked resource from the registry of networked resources, the selecting based on at least one of:
a metric indicating suitability of the selected networked resource for the given data processing segment; and
an output of a random number generator;
setting a time-out duration for completion of processing of the given data processing segment at the selected networked resource; and
routing the given data processing segment to the selected networked resource.
